(19) United States
(12) Patent Application Publication
(10) Pub. No.: US 2010/0046940 A1
(43) Pub. Date: Feb. 25, 2010

(54) Reliable Power Source for Fiber to Home Network Termination and Other Critical Applications

(75) Inventors: John Michael Cotton, Rochester, NY (US); Douglas R. Milliman, Baldwinsville, NY (US); Neil C. Olsen, Milford, CT (US); Perlis Joseph Trahan, Ontario, NY (US); Robert Alan Macaluso, Webster, NY (US)

Correspondence Address: CROWELL & MORING LLP;INTELLECTUAL PROPERTY GROUP, P.O. BOX 14300, WASHINGTON, DC, 20044-4300, US

(73) Assignee: Generonix, Inc., Rochester, NY (US)

(21) Appl. No.: 12/544,348

(22) Filed: Aug. 20, 2009

Related U.S. Application Data
(60) Provisional application No. 61/091,104, filed on Aug. 22, 2008.

(51) Int. Cl. H04B 10/08; H04M 3/08

(52) U.S. Cl. 398/17; 379/33

(57) ABSTRACT

A system and apparatus are provided for supplying network line power (NLP). In one embodiment a network line power termination (NLPT) provides NLP to a network termination. The NLPT includes input terminals configured to receive network line power from a network communication line, and at least one voltage converter configured to receive the enhanced voltage received from the network communication line to supply DC voltage. Output terminals of the NLPT are coupled to the voltage converter and may be configured to output converted voltage. The NLPT may be further configured for outputting voltage converted by the voltage converter as one or more of a reliable primary or backup power source for a network termination.

### CROSS REFERENCE TO RELATED APPLICATION

This Application claims the benefit of U.S. Provisional Application No. 61/091,104, filed Aug. 22, 2008.

### FIELD OF THE INVENTION

The present invention relates in general to the provision of Network Line Power (NLP) for electrical, electronic, and electromechanical applications, and more particularly to providing primary or backup power for an optical network terminal.

### BACKGROUND

There are numerous electrical, electronic or electromechanical systems, such as, for example, a digital subscriber line access multiplexer (DSLAM), repeater, cell tower, and fiber optic network termination for Fiber-to-the-Home (FTTH) which require a highly reliable power supply. FTTH service allows for the provision of high bandwidth connections to a customer's home by means of fiber optic cables used to provide voice, high bandwidth data (e.g., Internet access), and/or multimedia services such as video. Fiber-to-the-Premises (FTTP) may also be used to describe this service as high bandwidth networks are also used to provide service to business customers in office buildings and remote locations, such as warehouses and cell sites. These services may be provided by local exchange carriers (LECs). Further, LECs may provide these services to compete with cable based service providers.

FTTH networks have been offered in new construction (e.g., “Greenfield applications”), where fiber-optic cables are pre-installed at each customer location. Whether the homeowner wishes to make use of this facility may be a question of the competitive nature of the service. This, in turn, is very dependent on the costs of the network termination and its power supply. Some LECs offer FTTH in existing housing developments (e.g., “Brownfield applications”), where fiber optic cable is not normally installed. Fiber optic services may be more difficult to install in existing developments and the service usually competes with existing cable services. As a result, the cost for providing service may be critical to retain customers and/or lure cable customers to FTTH service.

FTTH networks may also service multiple dwelling units (MDUs) which represent about 32% of residential dwellings in certain areas. One difficulty in employing a FTTH for a multiple dwelling unit may be the cost associated to run separate fiber cables to each dwelling unit and supplying each unit with separate power. As a consequence, a single Multi Dwelling Unit (MDU) is used with a single power supply to service a group of dwellings. Similarly, FTTP networks may be used in business establishments having multiple offices sharing a fiber line and/or in remote locations such as cell sites, that also require reliable access to fiber networks.

FTTH service typically requires equipment at a customer premises for detection and conversion of data transmitted over fiber optic cables. The equipment typically requires electrical power for operation. When a power source for the customer premises equipment fails, services and/or data provided over the fiber optic channel may not be retrieved. Further, while video and data are currently considered non-essential services, Federal Communication Commission (FCC) regulations and/or other government agency regulations require a minimum power backup time for equipment to support at least one primary voice line or a so called “Lifeline phone” service to provide voice communication in emergencies even when local power fails. Thus, FTTP and FTTH networks may require a reliable power source to be independent of failure prone power utility sources, or as a backup where the power utility is used as the primary power source.

As such, what is needed is a system for supplying reliable power to a customer premises in order to overcome one or more of the aforementioned drawbacks.

### BRIEF SUMMARY OF THE INVENTION

Disclosed and claimed herein are systems and apparatus for providing network line power (NLP). In one embodiment, a network line power termination (NLPT) includes input terminals configured to receive network line power from a network communication line, at least one voltage converter configured to receive the enhanced voltage received from the network communication line to supply DC voltage and output terminals configured to output the converted voltage. The network line power termination is further configured for outputting voltage converted by the voltage converter either as one or more of a primary and a backup power source for a network termination. Other aspects, features, and applications of the invention will be apparent to one skilled in the relevant art in view of the following detailed description of the invention.

### BRIEF DESCRIPTION OF THE DRAWINGS

The features, objects, and advantages of the present invention will become more apparent from the detailed description set forth below when taken in conjunction with the drawings in which like reference characters identify correspondingly throughout and wherein:

FIG. 1 depicts a simplified diagram of a system for providing network line power in accordance with the principles of the invention;

FIG. 2 depicts a simplified diagram of a central office arrangement according to one embodiment of the invention;

FIG. 3 depicts a simplified diagram of a network line power termination circuit according to one embodiment of the invention;

FIG. 4 depicts a circuit diagram for power arrangement to an optical network terminal (ONT) and additional optional unspecified equipment according to one embodiment of the invention;

FIG. 5 depicts a power switchover arrangement according to one embodiment of the invention;

FIG. 6 depicts a power hold-off arrangement according to one embodiment of the invention;

FIG. 7 depicts a control point switchover arrangement according to one embodiment of the invention; and

FIGS. 8A-8C depict mounting arrangements for a network line power termination according to one embodiment of the invention.

### DETAILED DESCRIPTION OF EXEMPLARY EMBODIMENTS

One aspect of the present invention relates to providing network line power (NLP). NLP may allow for electrical, electromechanical or electronic equipment, such as an optical network terminal (ONT) to continue operating in a communications network during a power utility failure. In one embodiment, an ONT converts optical signals and electrical signals used to deliver television, data service (e.g., Internet services), digital telephony and/or media services in general to subscribers for one or more of a residence, apartment, single or multiple dwelling unit, and business location which is offered a fiber optic connection to a digital or analog network. Providing these services by the ONT requires local uninterrupted power. Many ONTs are powered by utility services. However, during a power failure many ONTs fail to operate without power.

To meet the Federal Communication Commission (FCC) regulations and/or other government agency regulations to provide at least one primary voice line or a so called “Lifeline phone” service, power may be supplied to critical systems and components of a network, such as an ONT, by one or more of: 1) a separate local battery backup system (e.g., uninterrupted power supply (UPS) inside a dwelling or structure where service is provided; 2) a UPS on the outside of the dwelling or structure; 3) batteries embedded in an ONT; 4) NLP supplied from a neighborhood UPS; and 5) in accordance with one or more embodiments of the invention, NLP supplied from a central office or remote terminal that includes a battery source and back up charging equipment and/or power generators which operate in emergencies. Further, power supplied to components of a network may be in accordance with regulatory agencies according to another embodiment. Thus, NLP according to the invention may be in accordance with Federal Communication Commission (FCC) regulations and/or other government agency regulations which require a minimum power backup time for equipment to support such primary line or “lifeline” services.

In one embodiment, a backup power system for providing NLP includes a backup power installation, a network line power termination (NLPT) coupled to the network communication line, the NLPT configured to convert the enhanced voltage received from the network communication line to supply DC voltage, and an ONT and/or other power critical equipment electrically coupled to the NLPT and an optical communication medium wherein the ONT is configured to supply one or more communication services for a customer premise. The NLPT can supply DC voltage to the optical network termination as a primary reliable power source or as a backup power source. According to another embodiment, the NLPT may be provided to supply backup power for any equipment requiring a reliable power source.

Although the present disclosure is directed to an ONT, it should be appreciated that the systems and methods described herein may apply to other network components and/or network terminations including a digital subscriber line access multiplexer (DSLAM), repeater, network component configured to receive network line power in general, etc. It should also be appreciated that application of the present disclosure is not limited to an ONT or ONT applications. The systems and methods described herein may be employed to provide a primary and/or backup power source for network components and/or any electronic or electromechanical application by means of a NLPT.

As used herein, the terms “a” or “an” shall mean one or more than one. The term “plurality” shall mean two or more than two. The term “another” is defined as a second or more. The terms “including” and/or “having” are open ended (e.g., comprising). The term “or” as used herein is to be interpreted as inclusive or meaning any one or any combination. Therefore, “A, B or C” means “any of the following: A; B; C; A and B; A and C; B and C; A, B and C”. An exception to this definition will occur only when a combination of elements, functions, steps or acts are in some way inherently mutually exclusive.

Reference throughout this document to “one embodiment”, “certain embodiments”, “an embodiment” or similar term means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner on one or more embodiments without limitation.

### EXEMPLARY EMBODIMENTS

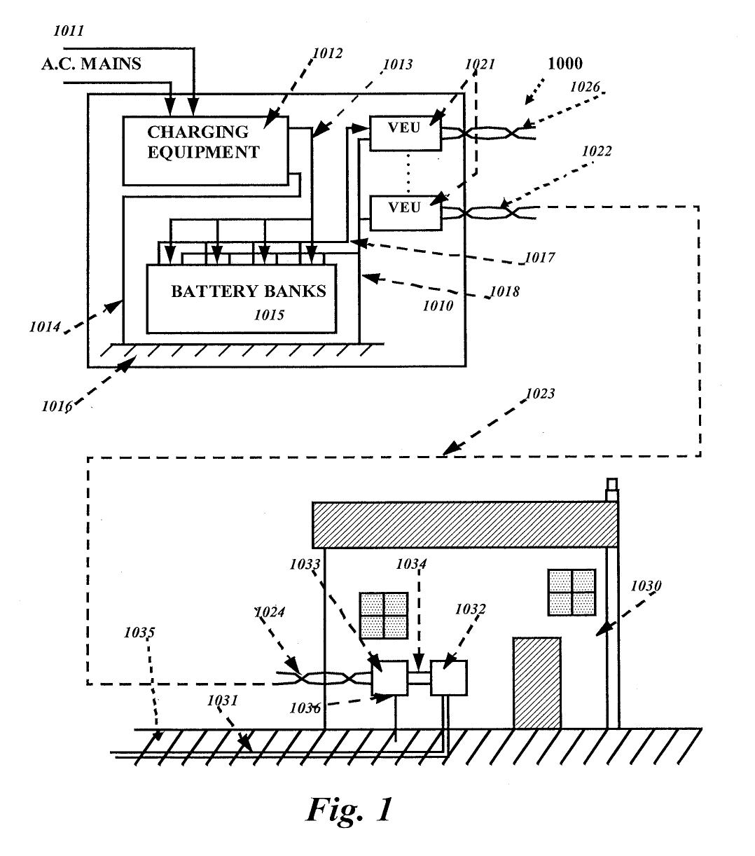

With reference to FIG. 1, depicted is a simplified diagram of a system for providing network line power (NLP) according to one embodiment. As shown, system 1000 includes central battery power installation 1010 configured to supply power to one or more of terminals 1022 and 1026. In one embodiment, central battery power installation 1010 includes battery banks 1015 comprised of one or more cells. Battery banks 1015 may be configured to supply DC voltage which may be employed to supply NLP. In one embodiment, battery banks 1015 may be maintained by charging equipment 1012. In one exemplary embodiment, charging equipment 1012 may supply charging current at −48 volts DC over connection 1013 to battery banks 1015. Charging equipment 1012 may consist of transformers and rectifiers fed from an AC power utility mains 1011. In an alternative embodiment, charging equipment 1012 may include a diesel generator (not shown). A positive terminal of charging equipment 1012 may be grounded by connection 1014, and a positive terminal of the battery banks 1015 may be grounded by connection 1018 to ground 1016. In one embodiment, battery power installation 1010 relates to a central power installation. However, in other embodiments, battery power installation 1010 may be remotely located and or arranged for one or more service locations.

Reliable DC electrical power may be supplied from central office batteries, such as battery banks 1015, to drive an electronic or electromechanical application over 1026 according to one embodiment, or a Fiber-to-the-Home (FTTH) optical network termination (ONT) over connection 1022 according to another embodiment. Battery power installation 1010 may include one or more voltage enhancement units (VEU) 1021. Each VEU may be coupled to battery banks 1015. In an exemplary embodiment, VEU may be fed with DC power at −48 volts over connection 1017.

According to one embodiment, reliable DC electrical power may be supplied by central office batteries, such as battery banks 1015, to drive an electronic or electromechanical application, using a Fiber to the Home (FTTH) Outside Network Termination (ONT). Battery banks 1015 may be continuously charged. Each ONT may require as much as 30 watts or greater at 12 volts DC for operation. At 1000 feet using 22 gauge copper wire (i.e., the most favorable case), un-enhanced −48 volts can only supply 18 watts because of power loss and voltage drop in the cable. Thus, it may be necessary to boost battery supplied −48 volts to a much higher value, in this example ±190 volts DC. The boosted voltage can deliver 460 watts at 1000 feet of 26 gauge wire, but for safety reasons (NE 830) the boosting equipment limits the output power to 90 watts. In that fashion, each VEU 1021 can deliver ±190 volts of enhanced DC voltage to terminal 1022 and/or 1026. Terminals 1022 and 1026 may be coupled to network transmission lines including, but not limited to a copper twisted pair.

Battery power installation 1010 may be configured to supply NLP for one or more applications. Thus, terminal 1026 illustrates the possibility of feeding the line power from a VEU to an application (not shown) other than Fiber to the Home (FTTH). By way of example, NLP may be configured to provide power for communication systems, lighting systems, security systems and/or emergency services.

As shown in FIG. 1, terminal 1022 is coupled to copper twisted pair 1023. Copper twisted pair 1023 may be a telephone cable of significant length and may be coupled to a dwelling network line power termination (NLPT) 1033 by local drop wire 1024. In one exemplary embodiment, local drop wire 1024 feeds the ±190 volts as degraded by the resistance of copper twisted pair 1023 to NLPT 1033. NLPT 1033 is shown mounted on the outer wall of dwelling 1030, however it may be equally appreciated that NLPT 1033 may be mounted to other structures including commercial buildings and structures in general.

In one embodiment, DC voltage delivered from the NLPT 1033 may be fed over connection 1034 to ONT 1032. ONT 1032 may be configured to detect and/or convert optical signals on connection 1031 to provide one or more of Television services, data services (e.g., Internet access), and digital telephony to the subscribers in dwelling 1030.

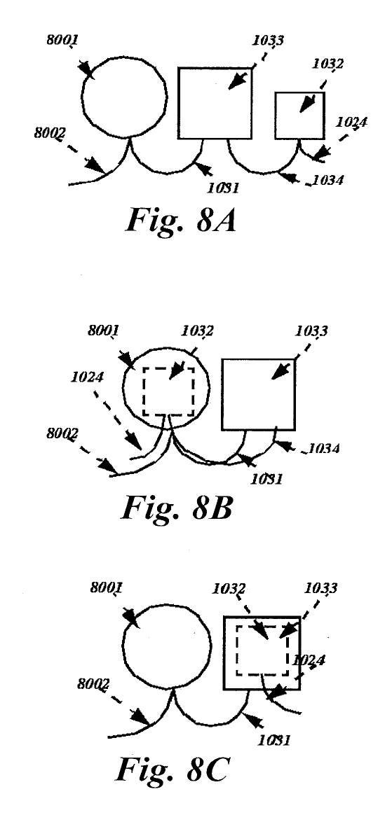

ONT 1032 is shown mounted on the external wall of dwelling 1030. As will be described in more detail below with respect to FIGS. 8A-8C, ONT 1033 may also be arranged in one or more different locations. Optical connection 1031 relates to a fiber optic line and is shown as a buried cable, but might equally well be supplied by aerial connection. The ground connection 1036 from NLPT 1033 ensures that any ground fault may be transmitted over local ground 1035 to ground 1016 of battery installation 1010 to trip a safety alarm.

The conversion of the optically transmitted data into electrical signals (and vice versa) may be performed by ONT 1032 and sometimes an Optical Network Unit (ONU) not shown in FIG. 1. ONT 1032 can provide subscribers with access to a “triple play” of media services: voice, video, and broadband data. Although video and data may be considered non-essential services, at least one primary voice line or so called “Lifeline phone” service is required to support voice communication in emergencies even when local AC power fails. Thus, ONT 1032 may be mounted on the outside of dwelling 1030 or another structure with fiber optic access. In the absence of electrical power to ONT 1030 by power supply of dwelling 1030, NLP may be configured to supply the required DC voltage for operation. In certain embodiments, 12 volts, up to, for example, 30 watts may be required for a single living unit. Alternatively, 12 or 48 volts DC and up to, for example, 55 watts may be required when ONT 1032 supports multi-dwelling units.

System 1000 may be configured to comply with regulations, such as FCC rules requiring that any voice service offered by the LECs shall survive a power utility failure by a minimum of 8 hours. In certain embodiments, ONT 1032 may include 120 volt AC/DC power converters, with the cost of power being bourn by the subscriber. However, an AC/DC power converter will not supply power to ONT 1032 during a power failure to meet the 8 hour requirement. One advantage of the current invention may be to remove the cost of the supply of power from the LEC, except when the power utility ceases to provide power. As will be described in more detail below with references to FIGS. 5-7, alternate arrangements may be employed to ensure backup power equipment comes into operation only as required.

Referring now to FIG. 2, a simplified diagram of a central office arrangement for providing network line power is shown. Central office installation 2001 may be configured to provide NLP according to one or more embodiments of the invention. As shown in FIG. 2, battery bank 2007 includes 12 volt batteries coupled to provide power output 2011 of −48 volts with respect to ground 2004. Power output 2011 couples the −48 volt DC to input connections of one or more VEUs 2002, (e.g., VEU units 1021 shown in FIG. 1).

In one exemplary embodiment, VEU 2002 may be configured to generate voltage limited to ±190 volts with respect to ground 2004 for output connections 2010, with a maximum short circuit output current of 260 milliamps. In another embodiment, VEU 2002 may be configured to limit the positively and negatively enhanced voltages and a maximum available short circuit output current to values within at least one safety standard. These values may be specified to meet safety standards UL60950-21, GR-001089-CORE and NEC 830. According to another embodiment, VEU 2002 may be configured to output positively enhanced voltage on a first copper line and negatively enhanced voltage on a second copper line, wherein the first and second copper lines form a twisted pair. VEU 2002 may further be configured to provide continuous power under fault free conditions to one or more NLPTs.

According to another embodiment, ground currents may be monitored for each VEU by means of detecting a ground current greater than a threshold value. In the event a ground fault is detected, the ±190 volt outputs of the affected VEU are disconnected by means of ground fault (GF) 2005 controlled relays 2006. VEU 2002 may be electrically coupled to ground and configured to measure ground currents associated with the enhanced voltage feeds of its output and further configured to detect a ground current in excess of a given value, and disconnect the enhanced voltage outputs and initiate an alarm for system 2001.

Output lines 2010 may be protected from lightning and power surges by means of a protection circuit 2003 consisting of series fuse 2008 in each line, and a parallel voltage dependent breakdown device 2009 having a breakdown voltage greater than the output voltage. For example, 200 volt breakdown voltages may be provided by a series fuse, parallel tricil or similar device having a breakdown voltage above a maximum enhanced voltage received, connected from each line to ground 2004 between the fuse and VEU 2002.

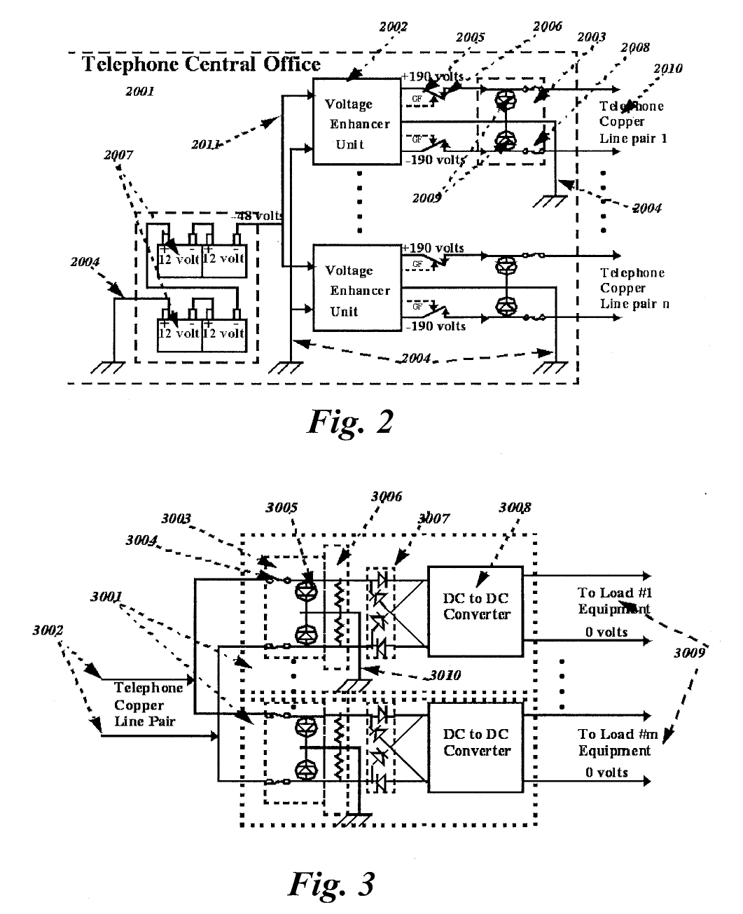

Referring now to FIG. 3, depicted is a simplified diagram of a network line power termination (NLPT) circuit according to one embodiment of the invention. As shown in FIG. 3, single telephone copper line pair 3002 may provide NLP for a plurality of NLPT units, shown as 3001, according to one embodiment. Copper twisted pair 3002 may supply ±190 volts DC generated by a VEU (e.g., VEU 2002), as degraded by the intervening cable resistance 1023 described in FIG. 1, for the plurality of NLPT units 3001 connected in parallel. According to one embodiment, single telephone copper line pair 3002 may supply NLP for up to six NLPT units, depending on the circumstances of distance from the power source, power output required, and/or installation convenience. NLPT units 3001 may be configured for indoor and/or outdoor electronic and electromechanical applications.

According to one embodiment, inputs to NLPT units 3001 may be protected from lightning and voltage surges by modules 3003 consisting of series fuse 3004 in each line, and a parallel voltage dependent breakdown device 3005 having a breakdown voltage greater than the output. In that fashion, lightning and surge protection circuit may be provided for protecting an NLPT and a load from one or more of lightning and power surges carried by first and second copper lines of copper twisted pair 3002. The lightning and surge protection circuit includes one or more of a series fuse in each line, a parallel Tricil, and device having a breakdown voltage, connected from each line to ground between the fuse and a voltage converter.

In another embodiment, ±190 volts of copper twisted pair 3002 may be balanced with respect to ground by coupling each input line to ground 3010 by high value resistors 3006. The resistors 3006 may have equal values to ensure no consequential unbalanced ground current flows. Resistors 3006 may couple each of the first and second copper lines of copper twisted pair 3002 to ground, such that high value resistors 3006 ensure that ground current in the NLPT is below a value which will trigger a ground fault power cutoff and alarm in the one or more of an associated Central Office and remote terminal VEU.

To ensure that an incorrect connection of the input circuits will not damage converter circuits 3008, diode bridge 3007 is connected between the protection circuits and the actual voltage conversion circuits 3008. Diode bridge 3007 may be coupled between the lightning and surge protection circuit and a voltage converter to ensure correct operation when the first and second copper lines are reversely coupled. Voltage conversion circuits 3008 of NLPT 3003 may be custom designed, or a suitable commercially available DC/DC converter configured to generate the required DC voltage to drive the load 3009 requiring either −12 or −48 volts from a range of input voltages (from an upper value of ±190, down to some lesser values).

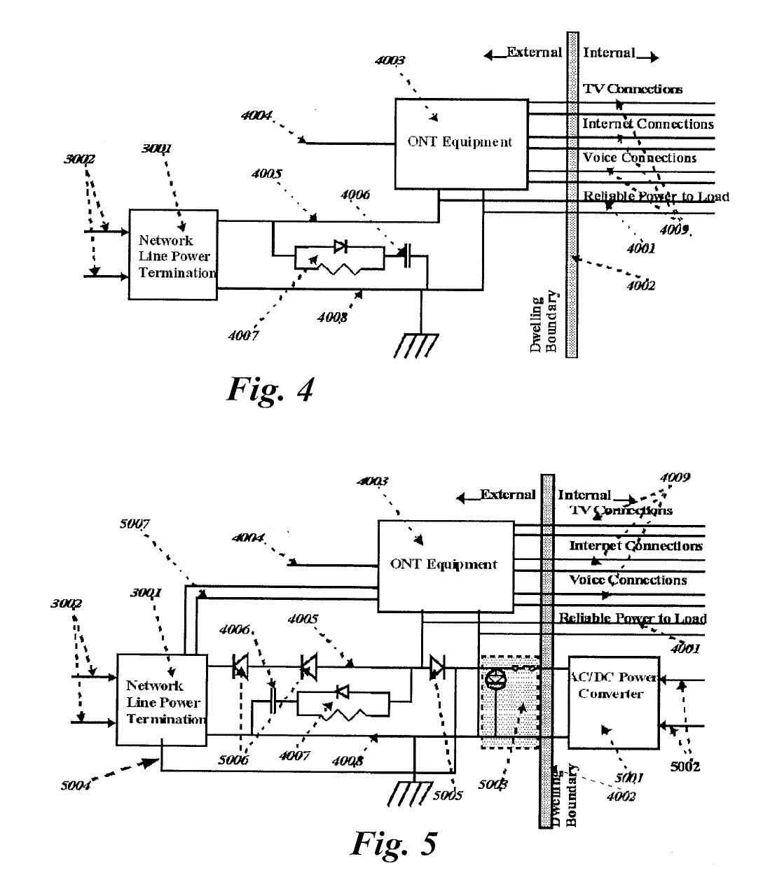

Referring now to FIG. 4, a circuit diagram is depicted for a supplying reliable primary power to an optical network terminal according to one embodiment of the invention. As shown, copper twisted pair 3002 delivers ±190 volts DC, which may be degraded to NLPT 3001 as described above with reference to FIG. 3. Output of NLPT 3001, shown as 4005, may be fed to a load which consists of an ONT 4003 and/or a connection 4001 to electronic or electromechanical equipment which requires reliable power. NLPT 3001 includes grounded output connection 4008.

In one embodiment, ONT 4003 and NLPT 3001 may be mounted on the outside wall of dwelling 4002. ONT 4003 is configured to provide electrical signals 4009 relating to television, data services (e.g., Internet access), digital telephony and/or power for a load through a wall or boundary of dwelling 4002. ONT 4003 may be configured to provide media services to one or more dwellings.

In certain embodiments, ONT 4003 may be part of the load and an additional short duration power surge required for a ring trip function is supplied from a capacitor 4006 which is charged by NLPT 3001 by means of the capacitor charging circuit 4007. In one embodiment, capacitor charging circuit 4007 consists of a resistor to limit inrush current to capacitor 4006 at start up, bypassed by a diode to allow the capacitor to deliver the required surge current. Capacitor 4006 may be charged by output voltage feeding the ONT 4003, such that the capacitor is configured to provide an additional current surge to service a Ring-trip function of a telephony voice circuit of the ONT 4003. Installation of the capacitor may be performed during or after the installation of ONT 4003. Capacitor 4006 may additionally be configured to provide a continuous power supply during a switch over from AC/DC Power Conversion Unit (APCU) in relation to NLPT 5001 of FIG. 5 below.

According to certain embodiments, each NLPT may be configured to provide emergency backup power to support an AC/DC Power Conversion Unit (APCU) in the event that the AC power utility ceases to provide service or the APCU fails. When two power sources are coupled to a load, it is necessary to isolate the power sources from each other with diodes, or some other method of ensuring only one power source is utilized at a time In one embodiment the APCU is given precedence by using a smaller number of isolating diodes than the NLPT. In another embodiment, a diode in the path from the APCU to the load and relay contacts placed in the path from the NLPT to the load, the diode and relay contacts configured to prevent the APCU and NLPT from supplying the load simultaneously, wherein the relay contacts are further configured to be held open by the voltage from the APCU. In yet another embodiment, a diode in the path from the APCU to the load and a control point in an output voltage converter of the NLPT configured, the diode and control point configured to prevent the APCU and NLPT from supplying the load simultaneously, wherein the control point is further configured to disable the NLPT when the control point is held grounded by a relay contact (e.g., switched contact) operated by the voltage from the APCU. In each of these embodiments, the NLPT units (e.g., NLPT units 3001) may be configured to provide a signal to a network termination to alert a signal recipient that the APCU is no longer providing power according to another embodiment.

Referring now to FIG. 5, depicted is a power switchover arrangement according to one embodiment of the invention. When two power sources are coupled to ONT 4003, it is necessary to isolate the power sources from each other with diodes, or some other method of ensuring only one power source is utilized at a time. FIG. 5 illustrates power sources 3001 and 5001. If the two power sources each deliver precisely the same DC voltage, the voltage drop across the two or more diodes 5006 in the NLPT backup supply connection 4005, as compared with the voltage drop across the single diode 5005 will ensure that the backup only comes into operation when the original AC driven supply 5001 fails. The power switchover arrangement of FIG. 5 allows for an inexpensive solution and may be satisfactory for some equipment tolerances.

Due to lightning and/or a high voltage power cross, it may be possible that incoming AC power leads 5002 could conduct electric surges which could damage NLPT 3001, ONT 4003 and/or a load. Thus, the power switch arrangement of FIG. 5 includes protection circuit 5003, similar to the protection circuit 2003, to prevent damage from surges. Protection circuit 5003 is introduced in the DC power connection between the AC/DC power source 5001 and isolation diode 5005. According to one embodiment, in the event that NLPT 3001 is required to supply to the load, the equipment constituting the load including ONT 4003, may need to be alerted. By way of example, when AC power is presumed to have failed, there would be no purpose served, for example, if power were to be continued to drive the Television signals. Thus, NLPT 3001 may provide an alert over the connection 5007, by means of relay contacts (not shown) in NLPT 3001, actuated by the loss of power on the connection 5004. The signal produced on connection 5007 may be a shorting of the two leads, power to the leads or grounding, as required by the load.

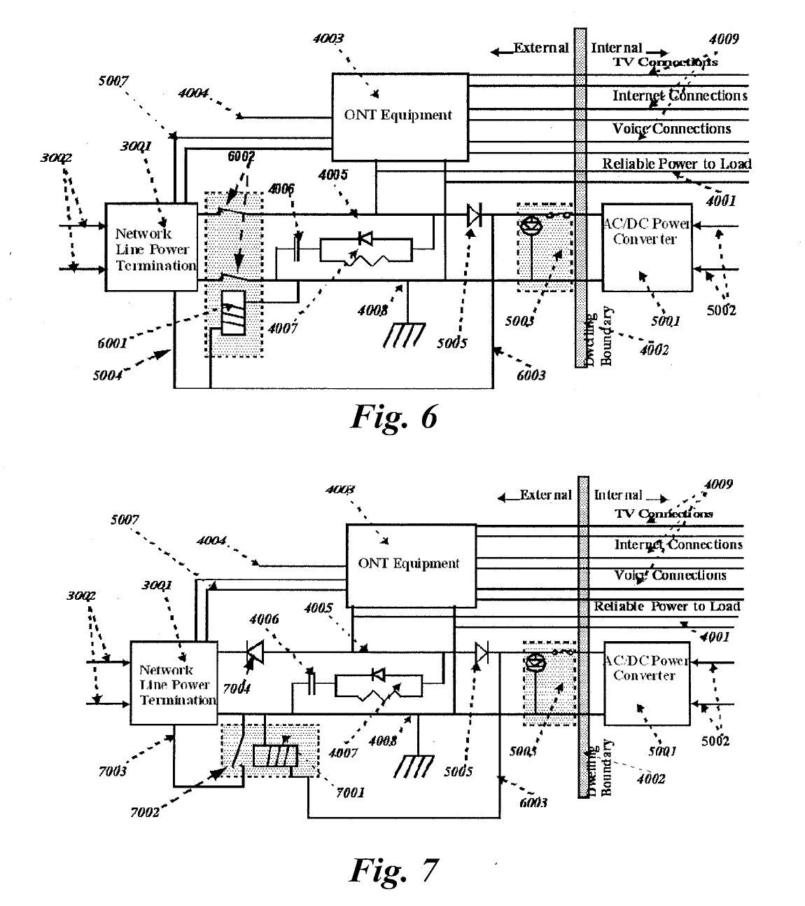

Referring now to FIG. 6, depicted is a power hold-off arrangement according to one embodiment of the invention. According to one embodiment, a certain way of ensuring that the backup supply 3001 only comes into service when needed is to use relay 6001 powered by a connection 6003 from primary power source 5001 to hold the backup connections open by means of two form B contacts 6002. Should the main power source fail, the relay will close for lack of current to hold it open. Diode 5005 in the lead from the power source 5001 will prevent the voltage from the backup power source 3001 from powering the relay when the backup comes on line. Capacitor 4006 will help to smooth the transfer of power source. An extension of connection 6003 into 5004 provides the actuation for generating the signal on the signaling leads 5007 as described for FIG. 5.

Referring now to FIG. 7, depicted is a control point switchover arrangement according to one embodiment of the invention. DC/DC voltage converter circuits may be designed to incorporate a control point, shown as 7003, which can disable the converter when grounded. In one embodiment, relay 7001 may be actuated by voltage from the primary power source 5001 through connection 6003 to ground control point 7003 by means of a Form A relay contact 7002. In that fashion, operation of the backup may be prevented until the primary power source fails. As described above with reference to FIG. 5, a diode 7004 is introduced into the connection from the NLPT to the Load, to prevent the power from the AC/DC unit from damaging the NLPT. The signal on the signaling leads 5007 may be actuated in the NLPT as a consequence of the voltage generated by the NLPT 3001, or by an additional contact (not shown) in the relay 7001, which is the backup power source.

Referring now to FIGS. 8A-8C, depicted are arrangements for housing one or more components of the NLP system. In one embodiment, an NLPT (e.g., NLPT 3001) may be designed to be mounted on the side of a building in its own enclosure. One or more aims of an NLPT housing according to the invention include design optimized for functionality in terms of being weather proof (e.g., all connections enter at a lowest point of a housing), ease of connectivity, heat dissipation, ease of manufacture, etc. Actual location of the NLPT enclosure, when in operation, may have little impact on functionality provided the orientation maintains the cable entries at the lowest point.

FIG. 8A depicts one embodiment, wherein NLPT 1032 is mounted on the outside of a building wall next to the ONT 1033. The incoming copper pair 1024 enters from the bottom of the NLPT housing, and the load servicing DC voltage connection 1034 for ONT 1033 leaves from the same orifice in the bottom. ONT 1033 is mounted on the side of the building, with optical cable 1031 and DC voltage connection 1034 entering from the bottom of an ONT enclosure. According to one embodiment of the invention an incoming optical network cable 8002 enters box 8001 (e.g., a slack box) configured to accommodate slack in the cable and allow expansion and/or contraction according the weather conditions. Optical cable 1031 into ONT 1033 comes out of box 8001.

According to another embodiment, NLPT 1032 may be mounted within the box 8001 as shown in FIG. 8B. One advantage may be a reduction in the number of items mounted on the outside wall of the dwelling. In an alternative embodiment, NLPT 1032 may be mounted within ONT 1031 as shown in FIG. 8C. In that fashion, mounting locations should have no effect on the functionality of NLPT 1032 provided the weather proof nature of NLPT 1032 is maintained and the accumulated heat does not cause the temperature of NLPT 1032 to exceed design limits. In yet another embodiment, functionality of NLPT 1032 may be incorporated within electronics of an ONT.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

What is claimed is:

1. A system which supplies Network Line Power (NLP) to any electronic or electromechanical application by means of a Network Line Power Termination (NLPT), the system comprising:
a Voltage Enhancer Unit (VEU) which is supplied with power from a central location having an uninterrupted power supply (UPS), wherein the VEU is configured to
receive DC voltage as input from the central location having the UPS, the UPS including a battery and at least one of backup equipment, rectifiers and diesel generators,
deliver a positively enhanced voltage on a first copper telephone line,
deliver a negatively enhanced voltage on a second copper telephone line, wherein the first and second copper lines form a twisted pair,
provide continuous power, under fault free conditions, to one or more NLPTs,
limit the positively and negatively enhanced voltages and a maximum available short circuit output current to values within at least one safety standard, and
wherein the VEU is electrically coupled to ground and measuring ground currents associated with the enhanced voltage feeds of its output and further configured to detect a ground current in excess of a given value, and disconnect the enhanced voltage outputs and initiate an alarm upon such detection; and
a Network Line Power Termination (NLPT) which is fed with DC power over at least one copper telephone line pair by a Voltage Enhancer Unit (VEU).

2. The system of claim 1, wherein the NLPT is configured to:
receive the first and second copper lines carrying enhanced voltage from the VEU, as degraded by the line resistance of the copper twisted pair; and
generate a DC voltage as output.

3. The system of claim 2, further comprising a lightning and surge protection circuit for protecting the NLPT and a load from one or more of lightning and power surges carried by the first and second copper lines, wherein the lightning and surge protection circuit includes one or more of a series fuse in each line, a parallel Tricil, a device in general having a breakdown voltage above a maximum enhanced voltage received, connected from each line to ground between the fuse and a voltage converter.

4. The system of claim 3, further comprising a high value resistor coupling each of the first and second copper lines to ground, wherein each high value resistor has the same resistance, the high value resistors configured to ensure that ground current in the NLPT is below a value which will trigger a ground fault power cutoff and alarm in the one or more of an associated Central Office or remote terminal VEU.

5. The system of claim 4, wherein the first and second copper lines are coupled to a diode bridge between the lightning and surge protection circuit and a voltage converter to ensure correct operation when the first and second copper lines are reversely coupled.

6. The system of claim 5, further comprising a plurality of NLPTs coupled to the first and second copper lines supplied by the VEU.

7. The system of claim 6, wherein each NLPT is configured to provide DC Network Line Power as the primary power source to one or more of indoor or outdoor electronic or electromechanical applications.

8. The system of claim 6, wherein each NLPT is configured to provide DC Network Line Power to an Optical Network Terminal (ONT) Unit for one of a single or multiple dwelling unit.

9. The system of claim 8, wherein the ONT Unit is configured to provide one or more of voice, data, and television communicating facilities to one or more dwellings.

10. The system of claim 9, further comprising a capacitor charged by output voltage feeding the ONT, wherein the capacitor is configured to provide an additional current surge to service a Ring-trip function of a telephony voice circuit of the ONT.

11. The system of claim 10, wherein the capacitor is configured to be mounted and electrically coupled for installation during or after installation of the NLPT.

12. The system of claim 11, wherein each NLPT may be configured to provide emergency backup power to support an AC/DC Power Conversion Unit (APCU) in the event that the AC power utility ceases to provide service or the APCU fails.

13. The system of claim 12, further comprising an isolating diode in each power path to a load, wherein each isolating diode prevents the APCU and NLPT from supplying the load simultaneously, and wherein the APCU is given precedence by using a smaller number of isolating diodes than the NLPT.

14. The system of claim 12, further comprising a diode in the path from the APCU to the load and relay contacts placed in the path from the NLPT to the load, the diode and relay contacts configured to prevent the APCU and NLPT from supplying the load simultaneously, wherein the relay contacts are further configured to be held open by the voltage from the APCU.

15. The system of claim 12, further comprising a diode in the path from the APCU to the load and a control point in an output voltage converter of the NLPT, the diode and control point configured to prevent the APCU and NLPT from supplying the load simultaneously, wherein the control point is further configured to disable the NLPT when the control point is held grounded by a relay contact operated by the voltage from the APCU.

16. The system of claim 12, further comprising a lightning and surge protection circuit for protecting the NLPT and the load from one or more of lightning and power surges conveyed by the APCU from AC power utility lines, wherein the lightning and surge protection circuit includes one or more of a series fuse in the DC power line from the APCU to the load, a parallel Tricil, and device having a breakdown voltage above APCU breakdown voltage, connected from a APCU output line to ground between the fuse and a load sharing diode.

17. The system of claim 12, wherein, the NLPT is configured to provide a signal to a network termination by a switched contact configured to alert a signal recipient that the APCU is no longer providing the power.

18. The system of claim 12, wherein the capacitor is configured to provide continuity of power supply during a switch over from AC/DC Power Conversion Unit (APCU) in relation to NLPT.

19. The system of claim 1, wherein the NLPT is configured to be mounted as one of a separate unit from a powered device, within an enclosure, within a fiber cable Slack Box associated with a network termination, within the same enclosure as a powered network termination, and incorporated into the circuitry of a network termination.

20. The system of claim 1, wherein the NLPT is configured to provide network line power to one of an Optical Network Termination (ONT), digital subscriber line access multiplexer (DSLAM), repeater and network termination configured to receive network line power in general.

21. A power system for providing network line power (NLP) comprising:
a power installation including at least one voltage enhancer unit configured to supply enhanced voltage over a network communication line;
a network line power termination (NLPT) coupled to the network communication line, the network line power terminal configured to convert the enhanced voltage received from the network communication line to supply DC voltage; and
a network termination electrically coupled to the network line power termination and an optical communication medium, the network termination configured to supply one or more communication services for a customer premise,
wherein the network line power termination is configured to supply the DC voltage to the network termination as a primary power source.

22. The power system of claim 21, wherein network communication line is a twisted copper pair.

23. The power system of claim 21, wherein the network line power termination comprises at least one DC to DC converter electrically coupled to the network communication line and the network termination.

24. The power system of claim 21, wherein the network line power termination is configured to supply the DC voltage to the network termination when a voltage source of the network termination fails.

25. The power system of claim 21, wherein the network termination is configured to provide at least one of voice, data, television and broadcast media services in general.

26. The power system of claim 21, wherein the network termination relates to one of an Optical Network Termination (ONT), digital subscriber line access multiplexer (DSLAM), repeater, and network termination configured to receive network line power in general.
